(19) United States
(12) Patent Application Publication
(10) Pub. No.: US 2022/0111699 A1
(43) Pub. Date: Apr. 14, 2022

(54) POWER MANAGEMENT FOR REFRIGERATION UNITS

(71) Applicant: Carrier Corporation, Palm Beach Gardens, FL (US)

(72) Inventor: Gilbert B. Hofsdal, Chittenango, NY (US)

(21) Appl. No.: 15/734,709

(22) PCT Filed: Jun. 23, 2020
(86) PCT No.: PCT/US2020/039036

§ 371 Date: Dec. 3, 2020

Related U.S. Application Data
(60) Provisional application No. 62/867,393, filed on Jun. 27, 2019.

(51) Int. Cl. B60H 1/00; B60H 1/32

(52) U.S. Cl. CPC B60H 1/00428; B60H 2001/3255; B60H 1/3205; B60H 1/3226

(57) ABSTRACT

Methods and systems for power management are provided. Aspects include receiving, by a controller, load data associated with two or more refrigeration systems, wherein the two or more refrigeration systems comprise at least a first refrigeration system and a second refrigeration system, determining, by the controller, an available power capacity for the first refrigeration system and the second refrigeration system, operating, by the controller, the first refrigeration system and the second refrigeration system in a plurality of modes based at least in part on the load data and the available power capacity, wherein the plurality of modes comprise an unloaded mode and a plurality of loaded modes.

### BACKGROUND

The subject matter disclosed herein relates to refrigeration systems. More specifically, the subject matter disclosed herein relates to power management of refrigeration units.

Goods are often transported across great distances, sometimes using a variety of different modes of transportation. One common method of transporting goods in such a manner is the use of intermodal shipping containers. Such containers are of a standardized size, such that multiple containers are easily handled and stacked. A common size is 8 feet (2.44 m) wide by 8 feet, 6 inches (2.59 m) high, with a length of either 20 feet (6.1 m) or 40 feet (12.2 meters). Other lengths can be used, such as 45 feet (13.7 m), 48 feet (14.6 m), and 53 feet (16.2 m). The benefit of standardized intermodal containers is that goods can be shipped from a variety of different locations without ever having to be removed from the container. The container itself is moved to and from a trailer, rail carrier, or ship.

Refrigeration containers onboard container ships often have access to a power plug to supply power for the refrigeration systems during transport. Some container vessels are designed with a specific number of power plugs that are designed for the high power consumption of older reciprocating compressor units of the refrigeration systems in the containers. For customers that are operating low power container refrigeration systems that utilize lower power consumption units (e.g., scroll units), one plug can be utilized for more than one container to effectively increase the amount of container units that can be utilized in an existing fleet of container vessels.

### BRIEF DESCRIPTION

According to one embodiment, a method is provided. The method includes receiving, by a controller, load data associated with two or more refrigeration systems, wherein the two or more refrigeration systems comprise at least a first refrigeration system and a second refrigeration system, determining, by the controller, an available power capacity for the first refrigeration system and the second refrigeration system, operating, by the controller, the first refrigeration system and the second refrigeration system in a plurality of modes based at least in part on the load data and the available power capacity, wherein the plurality of modes comprise an unloaded mode and a plurality of loaded modes.

According to one embodiment, a system is provided. The system includes two or more refrigeration systems, wherein the two or more refrigeration systems comprise at least a first refrigeration system and a second refrigeration system and a controller communicative coupled to the two or more refrigeration systems, the controller configured to perform receiving load data associated with two or more refrigeration systems, wherein the two or more refrigeration systems comprise at least a first refrigeration system and a second refrigeration system, determining, by the controller, an available power capacity for the first refrigeration system and the second refrigeration system, operating, by the controller, the first refrigeration system and the second refrigeration system in a plurality of modes based at least in part on the load data and the available power capacity, wherein the plurality of modes comprise an unloaded mode and a plurality of loaded modes.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an embodiment of a refrigerated transportation cargo container;

FIG. 2 depicts a diagrammatic illustration of an embodiment of a refrigeration system according to one or more embodiments;

FIG. 3 depicts a block diagram depicting system for power management between container according to one or more embodiments; and

FIG. 4 depicts a flow diagram of a method for power management according to one or more embodiments.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

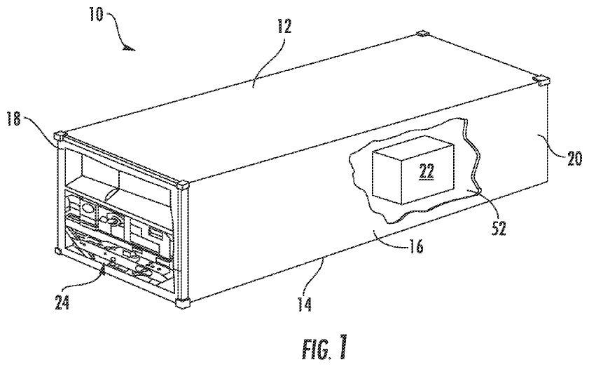

Shown in FIG. 1 is an embodiment of a refrigerated cargo container 10. The cargo container 10 is formed into a generally rectangular construction, with a top wall 12, a directly opposed bottom wall 14, opposed side walls 16 and a front wall 18. The cargo container 10 further includes a door or doors (not shown) at a rear wall 20, opposite the front wall 18. The cargo container 10 is configured to maintain a cargo 22 located in the interior 52 of the cargo container 10 at a selected temperature through the use of a refrigeration unit 24 located at the container 10. The cargo container 10 is mobile and is utilized to transport the cargo 22 via, for example, a truck, a train or a ship. The refrigeration unit 24 is located at the front wall 18, and includes a compressor, a condenser, an expansion valve, an evaporator, and an evaporator fan, as well as other ancillary components. The ancillary components include a refrigeration unit controller that can control operation of the refrigeration unit 24. For example, the refrigeration unit controller can operate individual components of the refrigeration unit 24 such as, for example, the compressor. In addition, the refrigeration unit controller can include or be in electronic communication with a transceiver configured to receive and transmit data over a wireless or cellular network. The cargo container 10 described herein is merely exemplary and not intended to limit the application, uses, and/or technical scope of the present disclosure, which can be embodied in various forms known in the art.

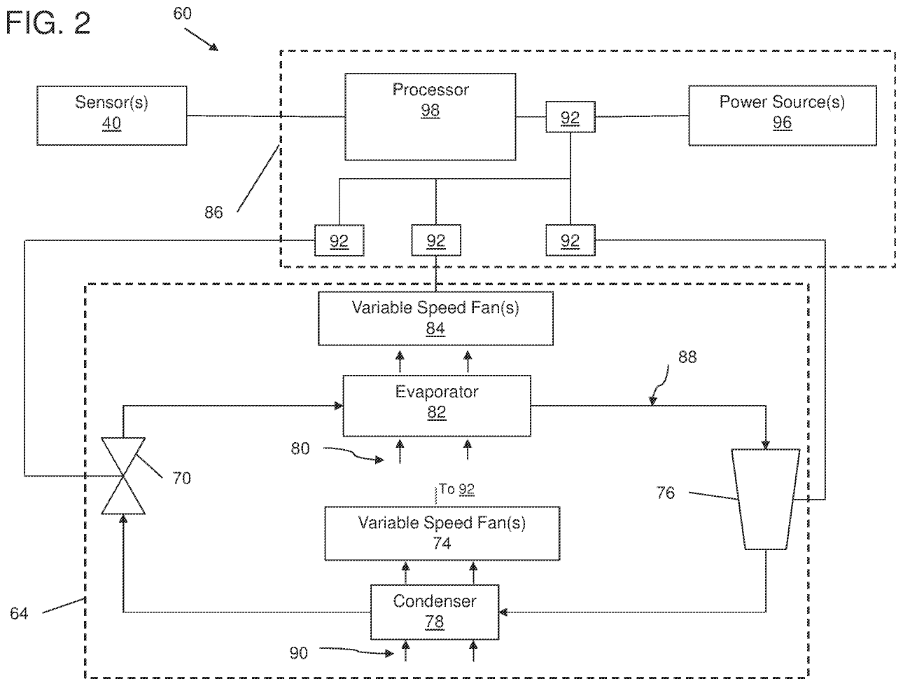

A diagrammatic illustration of an embodiment of a refrigeration system 60 is shown in FIG. 2. The refrigeration system 60 includes a power source 96, a refrigeration unit 64 configured with a compressor 76, a condenser 78, a refrigerant regulator 70, an evaporator 82, at fans 74, 84, and a control system 86 (“controller”). The refrigeration unit 64 is configured such that refrigerant travels through the compressor 76, the condenser 78, the refrigerant regulator 70 and the evaporator 82 in a closed loop path 88. The fan 84 has an alternating current (“ac”) motor or a direct current (“dc”) motor and is configured to condition air 80 from the interior compartment 52 in FIG. 1, and/or in some embodiments from outside the interior compartment 52 in FIG. 1, through the evaporator 82, and back into the interior compartment 52 in FIG. 1. The fan 74 has an alternating current (“ac”) motor or a direct current (“dc”) motor and is configured to move outside air 90, through the condenser 78, in order to reject heat out of the refrigeration system. The power source 96 is adapted to supply power to one or more of the components of the refrigeration unit 64 (e.g. the compressor 76, the refrigerant regulator 70, the fan 84, the fan 74, the controller 98, etc.).

The controller circuit 86 includes a processor 98 that is adapted to receive one or more feedback signals from one or more sensors 40, positioned within the interior compartment and/or the refrigeration unit 64, indicative of an environmental parameter (e.g., temperature, pressure, humidity, etc.) within the interior compartment, and/or feedback signals indicative of operating parameters of the refrigeration unit 64. The processor 98 is further adapted to selectively maintain or change the operating mode of the refrigeration unit 64, using actuators 92 (e.g., switches, valves, relays, triacs, FETs, transistors, and other power switching device) in communication with the refrigeration unit 64 based on the feedback signals, an algorithm, or some combination thereof. For example, a temperature value sensed within the interior compartment may prompt the controller 86 to engage a non-operating refrigeration unit 64 to supply cooling air to the interior compartment, or it may prompt the controller 86 to disengage an operating refrigeration unit 64. Similarly, an operating parameter value associated with the refrigeration unit 64 may prompt the controller 86 to engage a dormant refrigeration unit 64, or to disengage an operating refrigeration unit 64. It should be noted that the functionality of the processor 98 may be implemented using hardware, software, firmware, or a combination thereof. FIG. 2 is merely a non-limiting example presented for illustrative and explanatory purposes.

Turning now to an overview of technologies that are more specifically relevant to aspects of the disclosure, as described above, intermodal shipping containers are very useful for shipping goods through long distances, without the need to load and unload a single container multiple times through the journey. Certain intermodal containers are computerized, such as refrigerated intermodal containers. These intermodal containers can be transported aboard container vessels which are designed with a specific number of power plugs that are designed for the higher power consumption of older reciprocating compressor units. That is to say, these reciprocating compressor units can only be provided power from one power plug given the load requirements of these units and the available power supply from the power plugs. This one-to-one relationship limits the number of intermodal containers requiring a power supply that can be shipped onboard these container vessels.

Turning now to an overview of the aspects of the disclosure, one or more embodiments address the above-described shortcomings of the above described technologies by providing systems and methods for power management among intermodal shipping containers that allow for more than one container unit to utilize the same power plug. Aspects include utilizing, for two container units, low power consumptions units (i.e., scroll units/compressors) in the refrigeration systems on one power plug. A power controller can be utilized to manage the operation of the refrigeration systems on each of the two (or more) containers so that power is supplied to maintain proper temperature inside the containers without exceeding the available power supply. This allows shippers to potentially double their refrigerated shipments with no modifications to their vessels.

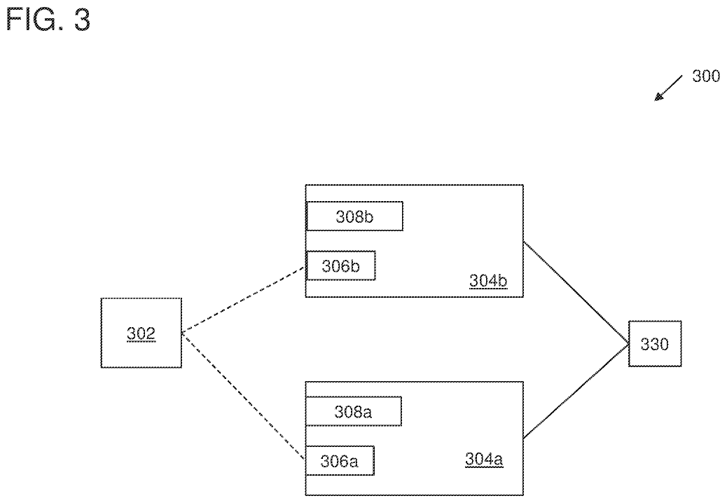

Turning now to a more detailed description of aspects of the present disclosure, FIG. 3 depicts a block diagram depicting system for power management between refrigeration units on containers according to one or more embodiments. The system 300 includes a first container 304a having a refrigeration controller 306a and a compressor 308a that is utilized in a refrigeration system on the first container 304a. Similarly, the system 300 includes a second container 304b with a refrigeration controller 306b and a compressor 308b that is utilized in a refrigeration system on the second container 304b. The system 300 also includes a power controller 302 that is operable to manage operation of the refrigeration controllers 306a, 306b to control the compressor cycling for each of the compressors 308a, 308b so that the power load does not exceed the available power supply 330. In one or more embodiments, the containers 304a, 304b are operated in a different operational modes such as a loaded mode when a compressor in a refrigeration unit is engaged and an unloaded mode when the refrigeration unit in a container is maintaining temperature (e.g., using fans, etc.). The power controller 302 manages the two containers 304a, 304b in these modes based on the load need for each container. In one or more embodiments, the available power supply 330 does not supply enough power to operate more than one container in the loaded mode when a compressor is engaged. Because of this restriction, the power controller 302 alternates between compressor cycles to maintain proper interior compartment temperature. Temperature data can be obtained from temperature sensors inside the containers and transmitted to corresponding refrigeration controllers 306a, 306b which can then transmit to the power controller 302 for analysis. Each of the power controller 302 and the refrigeration controllers 306a, 306b can include a transceiver that is configured to transmit and receive data over a wireless network. This data can include temperature data, content or inventory data in the containers, power load requirements, and any other operation data associated with the containers 304a, 304b. Based at least in part on this data, the power controller 302 can determine when and for how long to engage a compressor 308a, 308b for each the first container 304a and the second container 304b. While the illustrative example shows only two containers, in one or more embodiments any number of containers can be managed by the power controller 302 to share a power plug based on the available power supply 330. The compressors can be engaged by utilizing any number of algorithms or control logic. For example, having a temperature set point of 14° F. or higher (perishable cargo), a controller would attempt to run the compressor all the time and modulate the evaporator pressure to control temperature. The more modulated a compressor is, the less current it consumes. In most cases below 14° F. (Frozen cargo), the controller can cycle the compressor on and off. When temperature gets 4° above a set point the controller can turn the compressor on and when temperature reaches set point the compressor can be shut off. This operation and temperatures referenced can be customer specific. Customers have some ability to change the 14° F. trigger point. On top of the basic operation above the controllers can also do compressor on/off during perishable mode (quest mode) with configurable parameters for when the compressor changes from on/off.

In one or more embodiments, the power controller 302 can periodically receive data associated with the containers 304a, 304b to determine the operational mode for each container. As mentioned above, this data can be internal temperature data that can be utilized to determine when to engage a compressor for each container.

In one or more embodiments, the power controller 302 can operate the containers 304a, 304b in a current limiting mode which is discussed in further detail below. The current limiting (sometimes referred to as, “low current un-loaded mode” or “frozen control with compressor cycling mode”) can be utilized when both the first container 304a and the second container 304b would need to have their respective compressors 308a, 308b engaged at the same time.

In one or more embodiments, the two containers 304a, 304b sharing the power source 330 are paired. Each container will have a unique identifier utilized to pair the one with the other. When the first refrigerator controller 306a needs to start the first compressor in the first container 304, the power controller 302 will check the state of the second compressor for the second container 204b. If the second compressor is running fully loaded (i.e., maximum power consumption), the first refrigerator controller 306a requests that the second compressor unload, thereby decreasing current consumption, for a period of time. Once the second compressor has been given time to unload, the first compressor is started. Once the second compressor starts, each system will be allocated a certain amount of current (e.g., 15 amps) from the power supply 330 and the power controller 302 can continuously monitor the two compressors. Once both containers 304a, 304b are operating with the compressors on each being allocated a set (e.g., 15 amps) current consumption, if the first container 304a requires more than the set current consumption to operate at maximum capacity, the power controller 302 can check on the second container 304b to see if the second container 304b has any unused current allocation. If so, the power controller 302 can operate the first container 304 to utilize the excess current provided the total current consumption does not go above a maximum current consumption (e.g., 30 amps). At any point, the second container 304b may require the set (15 amps) current consumption, the first container 304a will need to give back the excess current. If either the first or second or both containers need more than the set current consumption, the power controller 302 will place the system 300 in a current limiting mode that limits the power consumption to the set current consumption (e.g., 15 amps). The limiting current will only slightly reduce capacity of the containers causing them to take a little longer to reach a cooling temperature; however, there are no issues controlling temperature once the cargo has been cooled.

In one or more embodiments, the power controller 302, transceivers, refrigeration controller 306a, 306b, and other components can be implemented by executable instructions and/or circuitry such as a processing circuit and memory. The processing circuit can be embodied in any type of central processing unit (CPU), including a microprocessor, a digital signal processor (DSP), a microcontroller, an application specific integrated circuit (ASIC), a field programmable gate array (FPGA), or the like. Also, in embodiments, the memory may include random access memory (RAM), read only memory (ROM), or other electronic, optical, magnetic, or any other computer readable medium onto which is stored data and algorithms as executable instructions in a non-transitory form. Additionally, a network can be utilized for electronic communication between and among the controllers and other devices. The network can be in wired or wireless electronic communication with one or all of the elements of the system 300. Cloud computing can supplement, support or replace some or all of the functionality of the elements of the system 300. Additionally, some or all of the functionality of the elements of system 300 can be implemented as a cloud computing node. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

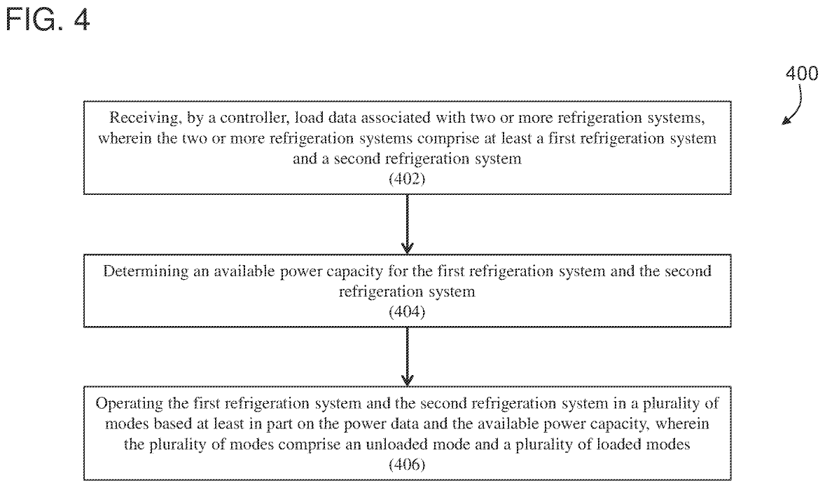

FIG. 4 depicts a flow diagram of a method for power management according to one or more embodiments. The method 400 includes receiving, by a controller, load data associated with two or more refrigeration systems, wherein the two or more refrigeration systems comprise at least a first refrigeration system and a second refrigeration system, as shown in block 402. The method 400, at block 404, includes determining an available power capacity for the first refrigeration system and the second refrigeration system. And at block 406, the method 400 includes operating the first refrigeration system and the second refrigeration system in a plurality of modes based at least in part on the power data and the available power capacity, wherein the plurality of modes comprise an unloaded mode and a plurality of loaded modes. The plurality of loaded modes allow for the units to balance the available power use without one unit needing to be turned off. One unit could use, say, 25% of available power while the other uses 75%, for example.

Additional processes may also be included. It should be understood that the processes depicted in FIG. 4 represent illustrations and that other processes may be added or existing processes may be removed, modified, or rearranged without departing from the scope and spirit of the present disclosure.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method for power management, the method comprising:
receiving, by a controller, load data associated with two or more refrigeration systems, wherein the two or more refrigeration systems comprise at least a first refrigeration system and a second refrigeration system;
determining, by the controller, an available power capacity for the first refrigeration system and the second refrigeration system;
operating, by the controller, the first refrigeration system and the second refrigeration system in a plurality of modes based at least in part on the load data and the available power capacity, wherein the plurality of modes comprise:
an unloaded mode, and
a plurality of loaded modes.

2. The method of claim 1, wherein the two or more refrigeration systems operate in a cargo container.

3. The method of claim 1, wherein operating the first refrigeration system in the unloaded mode comprises operating the first refrigeration system without engaging a compressor associated with the first refrigeration system.

4. The method of claim 1, wherein the plurality of loaded modes comprises a compressor loaded mode; and
wherein operating the first refrigeration system in the compressor loaded mode comprises operating the first refrigeration system by engaging a compressor associated with the first refrigeration system.

5. The method of claim 1, further comprising:
periodically receiving additional load data associated with the two or more refrigeration systems; and
further operating the first refrigeration system and the second refrigeration system in the plurality of modes based at least in part on the additional load data and the available power capacity.

6. The method of claim 4, wherein the available power capacity limits the operation of both the first refrigeration system and the second refrigeration system in the compressor loaded mode at a same time.

7. The method of claim 6, wherein the plurality of loaded modes further comprises a frozen control with compressor cycling mode; and
wherein responsive to determining a load requirement for the first refrigeration system and the second refrigeration system exceeding the available power capacity, operating the first refrigeration system and the second refrigeration system in the frozen control with compressor cycling mode.

8. The method of claim 1, wherein the load data comprises temperature data associated with an interior compartment for the two or more refrigeration systems.

9. The method of claim 1, wherein the load data comprises contents information for an inventory of an interior compartment for the two or more refrigeration systems.

10. The method of claim 1, wherein the controller receives the load data over a wireless network.

11. A system for power management, the system comprising:
two or more refrigeration systems, wherein the two or more refrigeration systems comprise at least a first refrigeration system and a second refrigeration system; and
a controller communicative coupled to the two or more refrigeration systems, the controller configured to:
receive load data associated with two or more refrigeration systems;
determine an available power capacity for the first refrigeration system and the second refrigeration system;
operate the first refrigeration system and the second refrigeration system in a plurality of modes based at least in part on the load data and the available power capacity, wherein the plurality of modes comprise:
an unloaded mode; and
a plurality of loaded modes.

12. The system of claim 11, wherein the two or more refrigeration systems operate in a cargo container.

13. The system of claim 11, wherein operating the first refrigeration system in the unloaded mode comprises operating the first refrigeration system without engaging a compressor associated with the first refrigeration system.

14. The system of claim 11, wherein the plurality of loaded modes comprises a compressor loaded mode; and
wherein operating the first refrigeration system in the compressor loaded mode comprises operating the first refrigeration system by engaging a compressor associated with the first refrigeration system.

15. The system of claim 11, wherein the controller is further configured to:
periodically receive additional load data associated with the two or more refrigeration systems; and
further operate the first refrigeration system and the second refrigeration system in a plurality of modes based at least in part on the additional load data and the available power capacity.

16. The system of claim 11, wherein the available power capacity limits the operation of both the first refrigeration system and the second refrigeration system in the loaded mode at a same time.

17. The system of claim 16, wherein the plurality of loaded modes further comprises a frozen control with compressor cycling mode; and
wherein responsive to determining a load requirement for the first refrigeration system and the second refrigeration system exceeding the available power capacity, operating the first refrigeration system and the second refrigeration system in the frozen control with compressor cycling mode.

18. The system of claim 11, wherein the load data comprises temperature data associated with an interior compartment for the two or more refrigeration systems.

19. The system of claim 11, wherein the load data comprises contents information for an inventory of an interior compartment for the two or more refrigeration systems.

20. The system of claim 11, wherein the controller receives the load data over a wireless network.
